(19) United States
(12) Patent Application Publication
(10) Pub. No.: US 2014/0234469 A1
(43) Pub. Date: Aug. 21, 2014

(54) APPARATUS FOR SHAPING DEEP-DRAWN CONTAINERS

(71) Applicant: AMCOR FLEXIBLES ZUTPHEN B.V., Zutphen (NL)

(72) Inventors: Dick Cornelius Verbeek, Apeldoorn (NL); Harry Johan Kettelarij, Lochem (NL)

(21) Appl. No.: 14/348,809

(22) PCT Filed: Sep. 20, 2012
(86) PCT No.: PCT/EP2012/003928

§ 371 Date: Mar. 31, 2014

(30) Foreign Application Priority Data
Oct. 1, 2011 (EP) 11 183 651. 6

(51) Int. Cl. B29C 51/08

(52) U.S. Cl. CPC B29C 51/085
USPC 425/398

(57) ABSTRACT

The invention relates to an apparatus for shaping deep-drawn containers, having a female die which has a conical recess and interacts with a male die body which, as the male die body dips into the female die, comes into an operative connection with a deformable material web, wherein the male die body consists of a male die ring which is composed of elastic material and a male die carrier. According to the invention, it is provided that the male die ring is arranged such that it can be moved with respect to the male die carrier in a plane perpendicularly with respect to the movement direction of the male die body.

### PRIOR ART

The invention relates to a device for shaping deep-drawn containers according to the preamble of claim 1.

A device of this type is known from WO 2011/012096 A1. In the known device, a male die body consisting of elastic material in the form of a male die ring is provided, which is either vulcanised on a male die carrier or connected to the male die carrier by means of an insert. As a result, the male die body is not only axially fastened or positioned with respect to its position in relation to the male die carrier, but also, moreover, in a plane perpendicular to the movement direction of the male die carrier or male die tool. Owing to the special shaping of the known device, deep-drawn containers can be produced with a high shaping precision and, in particular, can be particularly well stacked inside one another, so the handling of the containers produced from a deformable material web is simplified.

In the known device, the male die ring has a relatively high volume. When using the known device, in particular with high cycle rates, this leads to the fact that the male die ring heats up relatively strongly as a result of its shape changes (compression and subsequent relief again) owing to the deformation energy transmitted by way of the material web to the male die ring, and this heat is also transmitted to other components of the device, in particular the male die body. As a result, drawbacks are produced with regard to the dimensional and volume stability of the device. Moreover, the known male die ring has a relatively complex shape, which is expressed in an increased production outlay and therefore relatively high manufacturing costs. Furthermore, because of the relatively large height in the axial direction, it has a relatively large deformability, which makes the precise adjustment of the deep-drawing forces more difficult.

### DISCLOSURE OF THE INVENTION

Proceeding from the prior art shown, the invention is based on the object of developing a device for shaping deep-drawn containers according to the preamble of claim 1, in that, in particular, the mechanical and thermal properties of the male die ring are improved. This object is achieved according to the invention in a device for shaping deep-drawn containers having the features of claim 1 in that the male die ring is movably arranged with respect to the male die carrier in a plane perpendicular to the movement direction of the male die carrier. In other words, this means that when deep-drawing a container, the male die ring has the possibility of positioning itself in a plane parallel to the male die carrier, or changing its position (slightly). As a result, the possibility is provided of producing a male die ring with a reduced height compared to the prior art, and therefore, in particular, also a reduced volume. As a result, a lower heating of the male die ring is produced as a result of a lower deformation rate, or improved heat dissipation is produced with consequently greater thermal and geometric stability, in particular at high cycle rates.

Advantageous developments of the device according to the invention for shaping deep-drawn containers are specified in the sub-claims. All the combinations of at least two of the features disclosed in the claims, the description and/or the figures come within the scope of the invention.

Quite particularly preferred is a configuration of the device in which the mutually facing end faces of the male die ring and of the male die carrier, or an intermediate element, have a conical shape. As a result, when the male die tool dips into the material web, a centring of the male die ring on the male die carrier takes place. In this case, it is unnecessary for the conicity of the two end faces of the male die ring and the male die carrier to be the same. Only a conicity of the two end faces mentioned, which can bring about a self-centring, is important.

In order to reduce the production costs of the male die ring and simultaneously allow as simple as possible and therefore also a precise producibility of the male die ring, it is moreover proposed that the peripheral wall of the male die ring is planar.

In order to allow or to simplify an axial positioning of the male die ring on the male die carrier, it is proposed that the male die ring is axially prepositioned on the male die carrier by means of an insert connected to the male die carrier, said insert, on the side facing the male die ring, having a mushroom-shaped widening, which cooperates with a conical end face of the male die ring. The male die ring is thereby already positioned in a desired target position, in particular upon the first contact of the male die ring with the material web.

In order, for example, to be able to use one and the same male die carrier with different male die rings, or to be able to influence the dimensioning of the deep-drawn containers in a relatively simple manner, it may be provided that an annular intermediate element is arranged between the male die carrier and the male die ring. In this case, the annular intermediate element consists, in particular, of metal or of the same material as the male die carrier.

So that the mentioned self-centring of the male die ring with respect to the male die carrier is made possible, in the variant last mentioned, when using an intermediate element, it is preferably provided that the intermediate element, on the side facing the male die ring, has a conical end face with a cone angle between 0° and 20°, and in that the end face of the male die ring facing the end face is also conically configured with a cone angle between 0° and 20°.

As already explained, the male die ring has a reduced overall height compared to the prior art. In order to be able to shape conical containers, in which the diameter increases from the base to the edge region of the container, despite the reduced overall height, it may, moreover, be provided that the male die carrier has a peripheral wall with a conical region in the direction of the male die ring. As a result, the diameter of the male die carrier is reduced or minimised in the direction of the container base, so the male die carrier having direct abutment contact with the outer wall of the container in the region of the male die ring is avoided.

Quite particularly preferred is a geometric dimensioning of the male die ring, in which the height/diameter ratio of the male die ring is between 1:3 and 1:10.

Further advantages, features and details of the invention emerge from the following description of preferred embodiments and with the aid of the drawings.

In the drawings:

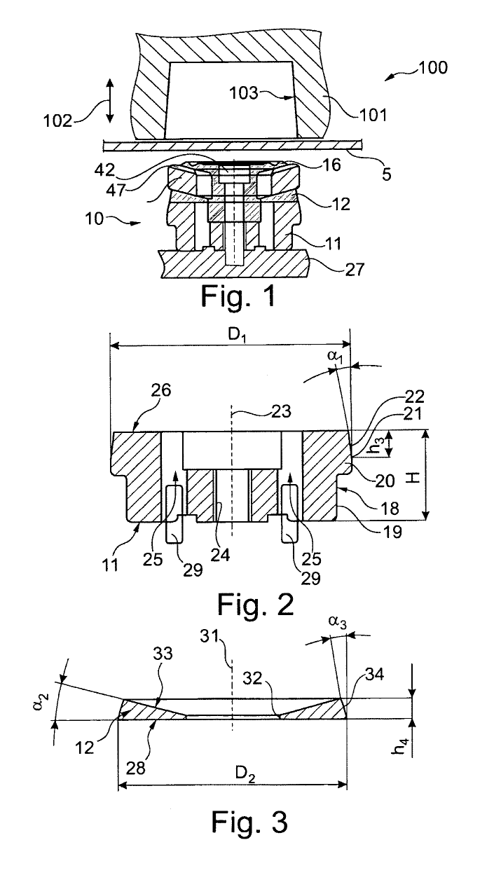

FIG. 1 shows a device for shaping rotationally symmetrical, deep-drawn containers made of a deformable material web in longitudinal section,

FIG. 2 shows a male die carrier of a male die tool, as used in the device according to FIG. 1, in longitudinal section,

FIG. 3 shows an intermediate plate of a male die tool according to FIG. 1, in longitudinal section,

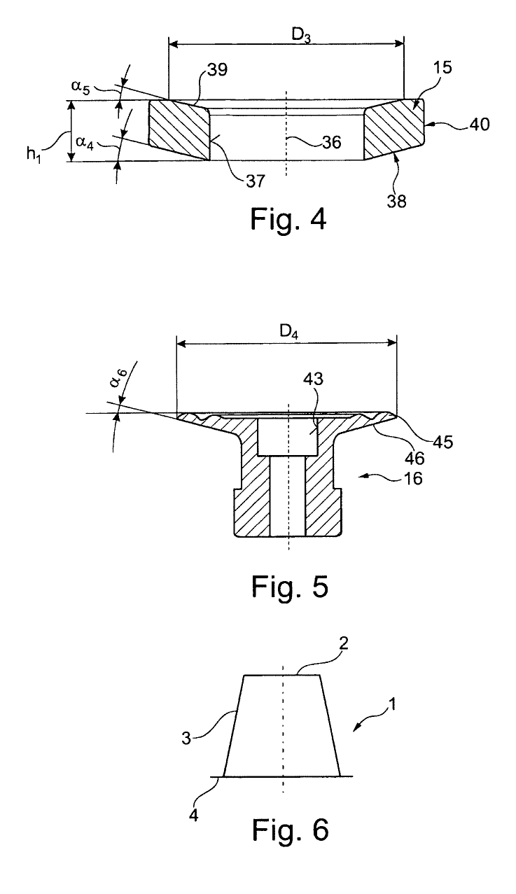

FIG. 4 shows a male die ring according to the invention, as used in the male die tool according to FIG. 1 in longitudinal section,

FIG. 5 shows an insert, as used in a male die tool according to FIG. 1, in longitudinal section, and

FIG. 6 shows a container that is deep-drawn by means of the device according to FIG. 1, also in longitudinal section.

The same components or components with the same function are provided with the same reference numerals in the figures.

In FIG. 1, a device 100 for shaping deep-drawn containers 1 is shown. According to FIG. 6, the containers 1 which are produced by means of the device 100 have a conical shape with a container base 2, a peripheral container wall 3 and a container edge 4, which projects radially outwardly in the plane of the opening region of the container 1 and can also be configured as a rolled container edge 4 in a modification of the shape shown in FIG. 6. The containers 1 are produced from a deformable material web 5, which, for example, contains an aluminium substrate. In particular, the aluminium substrate is at least one aluminium foil, which is coated by lamination and/or extrusion, such as by co-extrusion, with, for example, plastics materials or by lacquers. Typical material webs 5 may have one of the following two-layer structures, containing the layers:

sealing layer/aluminium foil/lacquer or

sealing layer/aluminium foil/core layer/aluminium foil/lacquer.

With respect to the precise structure or the thickness of the individual layers, the precise material composition of the individual layers and further possible material webs 5, reference is made to WO 2011/012196 A1 of the Applicant, which, to this extent is to be a component of this application.

The device 100 substantially consists of a female die 101, which is arranged to move up and down by means of a drive, not shown, in accordance with the double arrow 102. The female die 101, on the side facing the material web 5, has a recess 103, the shape of which is conical in accordance with that of the container 1.

The device 100, apart from the female die 101, comprises a stationarily arranged male die body 10, which is configured in four parts in the embodiment shown in FIG. 1. The male die body 10 has a male die carrier 11 consisting of metal, an annular intermediate element 12, preferably also consisting of metal, a male die ring 15 made of elastic material, and an insert 16.

It is additionally mentioned that the male die body 10 can also be configured in three parts. In this case, it may be provided that the intermediate element 12 is arranged in one piece on the male die carrier 11 or is connected thereto in one piece.

The male die carrier 11 with the height H, shown in FIG. 2 and consisting, in particular, of steel, is substantially annular and has a peripheral wall 18. The peripheral wall 18 has a portion 19, which is reduced in diameter on the side remote from the male die ring 15 and which is adjoined in the direction of the male die ring 15 by a portion 20 with an enlarged diameter. The portion 20 can either be configured to be continuously cylindrical, or else, in accordance with FIG. 2, comprise a first cylindrical region 21, adjoined by a second, conical region 22 with the height h₃, the inclination angle α₁ of which is, for example, between 1° and 12°. The diameter D₁ of the portion 20 corresponds to the internal diameter of the container 1.

Furthermore, the male die carrier 11, in its longitudinal axis 23, has a threaded bore 24 for fastening the male die body 10 by means of a fastening screw 42, shown in FIG. 1, on a carrier element 27, for example a carrier plate. In this case, the diameter of the threaded bore 24 is greater than the diameter of the fastening screw 42. For better cooling or heat dissipation, in particular of the male die body 10, a plurality of through-bores 25, preferably arranged at uniform angular intervals with respect to one another, are furthermore provided. Positioning pins 29, which serve for correct positioning of the male carrier 11 with respect to the carrier element 27, can be inserted in preferably two of these through-bores 25. The disassembly of the male die body 10 from the carrier element 27 and the positioning pins 29 takes place by means of the threaded bore 24 and the fastening screw 42. On the side facing the intermediate element 12, the male die carrier 11 has an end face 26 that is planar in the embodiment.

The also planar end face 28 of the intermediate element 12 shown in FIG. 3 rests on the end face 26 of the male die carrier 11. The annular intermediate element 12 with the height h₄ has an external diameter D₂, which is adapted to the diameter of the male die carrier 11 on its end face 28. Furthermore, a through-bore 32, which has the insert 16 passing through it, is configured in the longitudinal axis 31 of the intermediate element 12. The size or the diameter of the through-bore 32 is preferably adapted in such a way that a connection to the male die ring 15 is made possible by means of the through-bores 25 of the male die carrier 11 in order to dissipate heat from the region of the male die ring 15.

On the side facing the male die ring 15, the intermediate element 12 has a conical end face 33 with a cone angle α₂ between 0° and 20°. Furthermore, it may be provided that the (straight) peripheral wall 34 of the intermediate element 32 is also conical and has an inclination angle α₃, which provides a harmonious transition to the male die ring 15. In this case, the inclination angle α₃ is preferably the same size as the inclination angle α₁, in other words between 0° and 12°.

The rotationally symmetrical male die ring 15 shown in FIG. 4 may, for example, be made of natural rubber, an acrylonitrile butadiene rubber or of a urethane rubber, or at least contain these materials. Alternative male die body materials are synthetic polyisoprene rubber, styrene butadiene rubber, hydrated nitrile rubber, acrylic rubber, epichlorohydrin rubber, epichlorohydrin ethylene oxide rubber, chloroprene rubber, polybutadiene rubber, butyl rubber of ethylene propylene diene monomers.

The hardness of the male die ring 15 is between 50 ShA and 130 ShA, preferably between 70 ShA and 95 ShA.

The materials of the male die ring may contain activators and/or accelerators for a vulcanisation process mentioned below, softeners or plasticisers, stabilisers, in particular against oxidisation and ozone attack, processing aids, tackifiers and/or reinforcing agents or fillers. The male die ring 15 may, for example, contain carbon black, silicon oxide, alumina, chalk or lime as the reinforcing agents or fillers. The male die ring 15 may be provided, at least on its effective shaping surface or through the entire male ring material, with lubricants, for example fluoride-containing polymers or polyhalogen olifins, such as polytetrofluoroethylene (TEFLON®), a-boron nitride or graphite. Furthermore, dyes are also possible, which allow the male die ring 15 to appear in a desired colour, as desired or required.

The male die ring 15 has a through-bore 37 in its longitudinal axis 36. The end face 38 of the male die ring 15 facing the intermediate element 12 is conical and has a cone angle α₄ of, for example, 0° to 20°, the cone angles α₂ and α₄ of the end face 33 of the intermediate element 12 and the end face 38 of the male die ring 15 preferably being identical, but may also have different dimensions. It is only important that a self-centring of the male die ring 15 with respect to the intermediate element 12 is made possible by the selection of the corresponding cone angles α₂ and α₄.

The male die ring 15 has a height h₁, which is adapted to the size of the container 1 and, for example, is between 8 mm and 50 mm.

The height h₁ is preferably selected to be as small as possible. The height/diameter ratio of the male die ring 15 is preferably between 1:3 and 1:10. On the side remote from the end face 38, the male die ring 15 has a funnel-shaped depression 39 with a cone angle α₅ and a diameter D₃, the two cone angles α₄ and α₅ being able to be of different dimensions, the cone angles α₄ and α₅ being able to have values between 0° and 20°, for example.

The peripheral wall 40 of the male die ring 15 is straight and can either be cylindrical, or be configured with a cone angle (not shown) of up to 30°, depending on the shape of the container 1.

The intermediate element 12 and the male die ring 15 are axially prepositioned by means of the insert 16 shown in FIG. 5 with respect to the male die carrier 11 and connected thereto, in that the insert 16 is screwed by means of the fastening screw 42 (FIG. 1) to the carrier element 27. For this purpose, the insert 16 has a corresponding stepped bore 43 to receive the fastening screw 42. The insert 16, on the side facing the material web 5, is equipped with a mushroom-shaped widening 45 with the diameter D₄, the lower side 46 of which serves to rest on the depression 39 of the male die ring 15. For this purpose, the lower side 46 has a cone angle α₆ of, for example, 0° to 20°, the cone angle α₆ being adapted to the cone angle α₅ of the depression 39 of the male die ring 15. When the insert 16 is fitted, an annular gap 47 is formed between the male die ring 15 and the insert 16.

When producing the containers 1 by a downward movement of the female die 101 in the direction of the male die body 10, the material wall 5 comes into abutment contact with the male die body 10. In this case, the male die ring 15 can move in a horizontal plane, in other words perpendicular to the longitudinal axis 36 by a (small) amount, wherein, while dipping into the material web 5, it is centred by means of the shape of the recess 103 of the female die 101 and by means of the shape of the end faces on the intermediate element 12 and the male die ring 15.

The device 100 described thus far, or the male die body 10, may be modified in diverse manners, without deviating from the concept of the invention. This consists in minimising the volume of the male die ring 15, which results in a reduction in the required deep-drawing and holding forces. Furthermore, owing to the configuration according to the invention of the male die ring 15, less wear and therefore an increased service life of the male die ring 15 is made possible, with, at the same time, easy and economical producibility and easy assembly and easy exchange. It is also important for the male die ring 15 to be moveably arranged relative to the male die carrier 11 in a horizontal plane.

1. A device for shaping deep-drawn containers, with a female die, which has a conical recess and cooperates with a male die body, which, when the male die body dips into the female die, enters into an operative connection with a deformable material web, wherein the male die body consists of a male die ring, which consists of an elastic material, and a male die carrier wherein the male die ring is movably arranged with respect to the male die carrier in a plane perpendicular to the movement direction of the male die body.

2. A device according to claim 1, wherein mutually facing end faces of the male die ring and of the male die carrier, or an intermediate element, have a conical shape.

3. A device according to claim 1, wherein the peripheral wall of the male die ring is straight.

4. A device according to claim 1, wherein the male die ring is axially prepositioned on the male die carrier by means of an insert connected to the male die carrier, said insert having, on the side facing the male die ring, a mushroom-shape widening, the lower side of which cooperates with a conically configured end face of the male die ring.

5. A device according to claim 1, wherein an annular intermediate element is arranged between the male die carrier and the male die ring.

6. A device according to claim 5, wherein the intermediate element on the side facing the male die ring has a conical end face with a cone angle (α₂) between 0° and 20°, and wherein the end face of the male die ring facingthe end face is also conical with a cone angle (α₄) between 0° and 20°.

7. A device according to claim 6, wherein the two cone angles (α₂, α₄) of the intermediate element and the male die ring are the same dimension.

8. A device according to claim 1, wherein the male die carrier, in the direction of the male die ring, has a peripheral wall with a conically configured region.

9. A device according to claim 8, wherein the conically configured region has an inclination angle (α₁) between 1° and 12°, wherein the diameter of the male die carrier decreases in the direction of the male die ring.

10. A device according to claim 1, wherein the height/diameter ratio of the male die ring is between 1:3 and 1:10.

11. A device according to claim 4, wherein the conically configured end face is configured in the shape of a depression.
